(19) United States
(12) Patent Application Publication
(10) Pub. No.: US 2023/0199811 A1
(43) Pub. Date: Jun. 22, 2023

(54) METHODS FOR COMMUNICATION, TERMINAL DEVICE, NETWORK DEVICE, AND COMPUTER READABLE MEDIA

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 17/916,477

(22) PCT Filed: Apr. 3, 2020
(86) PCT No.: PCT/CN2020/083339

§ 371 Date: Sep. 30, 2022

(51) Int. Cl. H04W 72/51; H04W 72/23; H04L 5/00

(52) U.S. Cl. CPC H04W 72/51; H04W 72/23; H04L 5/0048

(57) ABSTRACT

Embodiments of the present disclosure provide a solution for scaling time for performing uplink and downlink transmissions. In a method for communications, a network device obtains a capability indicator of a terminal device. The network device determines a target scheduling scheme for the terminal device based on the capability indicator. The network device transmits information associated with the target scheduling scheme to the terminal device. The information associated with the target scheduling scheme causes the terminal device to perform uplink and downlink transmissions based on the target scheduling scheme. Embodiments of the present disclosure provides a more flexible and adaptive configuration and scheduling manner, and thereby improving communication performances and reducing the cost of terminal devices.

### FIELD

Embodiments of the present disclosure generally relate to the field of telecommunication, and in particular, to methods, devices, and computer readable medium for communications.

### BACKGROUND

With the development of communication technologies, the fifth generation (5G) mobile communications system, also referred to new radio (NR) technology, focuses on three main application scenarios, namely, the enhanced mobile broadband (eMBB), the massive machine type communication (mMTC) and ultra-reliable and the low latency communication (URLLC). In order to support these application scenarios, the NR adopts more flexible and effective resource allocation and scheduling manners than the previous generations, and the performance objectives of the NR aim to enable high data rates, reduced latency, energy savings, reduced costs, increased system capacity and a large-scale device connectivity.

A diversity of terminal devices with various device complexity and service requirements are supposed to operate in the 5G NR network, including but not limited to, smart phones, wireless-enabled tablet computers, laptop-embedded equipment (LEE), laptop-mounted equipment (LME), and/or wireless customer-premises equipment (CPE). In addition, reduced capability devices, such as, pressure sensors, humidity sensors, thermometers, motion sensors, accelerometers, actuators, smart watches, rings, eHealth related devices, etc., may also operate and communicate with each other in such an environment. These terminal devices vary from hardware functions, processing performances, form factors, service requirements, latency requirements, bitrates, battery life and so on. Conventionally, the terminal device may report radio access capability parameters including its processing time capability type to the base station. As such, the base station may in turn configure and schedule the terminal device based at least in part on the processing time capability type. For each processing time capability type, the terminal devices may be configured with a common scheduling scheme and a fixed time for performing uplink (UL) and downlink (DL) transmissions may be used. There is a need to scale the common scheduling schemes to adapt to various processing capability of different terminal devices.

### SUMMARY

In general, example embodiments of the present disclosure provide a solution of scaling time for performing UL and DL transmissions.

In a first aspect, there is provided a method for communications. The method comprises obtaining, at a network device, a capability indicator of a terminal device. The method also comprises determining a target scheduling scheme for the terminal device based on the capability indicator. The method further comprises transmitting information associated with the target scheduling scheme to the terminal device to cause the terminal device to perform uplink and downlink transmissions based on the target scheduling scheme.

In a second aspect, there is provided a method for communications. The method comprises receiving, at a terminal device and from a network device, information associated with a target scheduling scheme for the terminal device, the target scheduling scheme being determined based on a capability indicator of the terminal device. The method also comprises determining the target scheduling scheme based on the information. The method further comprises performing the uplink and downlink transmissions based on the target scheduling scheme.

In an third aspect, there is provided a network device. The network device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 illustrates an example communication process between a network device and a terminal device in accordance with some embodiments of the present disclosure;

FIG. 3 illustrates a flowchart of an example method in accordance with some embodiments of the present disclosure;

FIG. 4 illustrates a flowchart of another example method in accordance with some embodiments of the present disclosure;

FIG. 5 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X (vehicle-to-everything) communication, a Transmission/Reception Point (TRP), a Remote Radio Unit (RRU), a radio head (RH), a remote radio head (RRH), a low power node such as a femto node, a pico node, and the like.

As used herein, the term “terminal device” or “user equipment” (UE) refers to any device having wireless or wired communication capabilities. The communications may involve transmitting and/or receiving wireless signals using electromagnetic signals, radio waves, infrared signals, and/or other types of signals suitable for conveying information over air. Examples of the terminal device include, but not limited to, mobile phones, cellular phones, smart phones, personal computers, desktops, personal digital assistants (PDAs), portable computers, image capture devices such as digital cameras, gaming devices, music storage and playback appliances, pressure sensors, humidity sensors, thermometers, motion sensors, accelerometers, actuators, smart watches, rings, eHealth related devices, Internet appliances enabling wireless or wired Internet access and browsing, vehicle-mounted terminal devices, devices of pedestrians, roadside units, and the like. For the purpose of discussion, in the following, some embodiments will be described with reference to UEs as examples of terminal devices and the terms “terminal device” and “user equipment” (UE) may be used interchangeably in the context of the present disclosure.

In some embodiments, a terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is an eNB and the second RAT device is a gNB. Information related to different RATs may be transmitted to the terminal device from at least one of the first network device and the second network device. In some embodiments, first information may be transmitted to the terminal device from the first network device and second information may be transmitted to the terminal device from the second network device directly or via the first network device. In some embodiments, information related to configuration for the terminal device configured by the second network device may be transmitted from the second network device via the first network device. Information related to reconfiguration for the terminal device configured by the second network device may be transmitted to the terminal device from the second network device directly or via the first network device.

As used herein, the term “transmission reception point,” “transmission/reception point,” or “transmission and reception point” may generally indicate a station communicating with the user equipment. However, the transmission and reception point may be referred to as different terms such as a base station (BS), a cell, a Node-B, an evolved Node-B (eNB), a next generation NodeB (gNB), a Transmission Reception Point (TRP), a sector, a site, a base transceiver system (BTS), an access point (AP), a relay node (RN), a remote radio head (RRH), a radio unit (RU), an antenna, and the like.

That is, in the context of the present disclosure, the transmission and reception point, the base station (BS), or the cell may be construed as an inclusive concept indicating a portion of an area or a function covered by a base station controller (BSC) in code division multiple access (CDMA), a Node-B in WCDMA, an eNB or a sector (a site) in LTE, a gNB or a TRP in NR, and the like. Accordingly, a concept of the transmission and reception point, the base station (BS), and/or the cell may include a variety of coverage areas such as a mega-cell, a macro-cell, a micro-cell, a pico-cell, a femto-cell, and the like. Furthermore, such concept may include a communication range of the relay node (RN), the remote radio head (RRH), or the radio unit (RU).

In the context of the present disclosure, the user equipment and the transmission/reception point may be two transmission/reception subjects, having an inclusive meaning, which are used to embody the technology and the technical concept disclosed herein, and may not be limited to a specific term or word. Furthermore, the user equipment and the transmission/reception point may be uplink or downlink transmission/reception subjects, having an inclusive meaning, which are used to embody the technology and the technical concept disclosed in connection with the present disclosure, and may not be limited to a specific term or word. As used herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the term “resource,” “transmission resource,” “resource block,” “physical resource block,” “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some embodiments of the present disclosure. It is noted that embodiments of the present disclosure are equally applicable to other resources in other domains.

As used herein, the singular forms “a,” “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.”

As used herein, the terms “first”, “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The cellular communication system relies on accurate and efficient coordination and communication between the network device (e.g., the base station) and the terminal device ((e.g., the UE), and the network device and the terminal device may communicate with each other based on time slots (or slots for short) as defined in the 3GPP specifications. In order to facilitate configurations and scheduling of the channel resources, the terminal device may report its radio access capability parameters including the processing capability information to the network device. In some cases, the network device may request for the processing capability information of the terminal device.

The processing capability information may include a processing capability type indicative of the processing delay of the terminal device for performing DL and UL transmissions, for example, on the physical downlink shared channel (PDSCH) and physical uplink shared channel (PUSCH). Typically, the processing capability of the terminal device is classified as processing capability types 1 and 2. In the state of art, a corresponding scheduling scheme is defined for each processing capability type and known by both the network device and the terminal device. The common scheduling scheme indicates a predefined number of symbols, N₁, for performing DL transmission on the PDSCH and a predefined number of symbols N₂, for preparing UL transmission on the PUSCH. The following Tables 1-1 and 1-2 respectively show the PDSCH processing time and the PUSCH preparation time for processing capability type 1, and Tables 2-1 and 2-2 respectively show the PDSCH processing time and the PUSCH preparation time for processing capability type 2.

TABLE 1-1
PDSCH processing time for processing capability type 1

| | PDSCH decoding time N₁ [symbols] | |
|---|---|---|
| | | dmrs-AdditionalPosition ≠ pos0 in |
| | | DMRS-DownlinkConfig in either of |
| | dmrs-AdditionalPosition = pos0 in | dmrs-DownlinkForPDSCH-MappingTypeA, |
| | DMRS-DownlinkConfig in both of | dmrs-DownlinkForPDSCH-MappingTypeB |
| | dmrs-DownlinkForPDSCH-MappingTypeA and | or if the higher layer parameter is not |
| μ | dmrs-DownlinkForPDSCH-MappingTypeB | configured |
| 0 | 8 | N_{1, 0} |
| 1 | 10 | 13 |
| 2 | 17 | 20 |
| 3 | 20 | 24 |

TABLE 1-2
PUSCH preparation time for processing capability type 1

| μ | PUSCH preparation time N₂ [symbols] |
|---|---|
| 0 | 10 |
| 1 | 12 |
| 2 | 23 |
| 3 | 36 |

TABLE 2-1
PDSCH processing time for processing capability type 2

| | PDSCH decoding time N₁ [symbols] |
|---|---|
| | dmrs-AdditionalPosition = pos0 in DMRS-DownlinkConfig in both |
| | of dmrs-DownlinkForPDSCH-MappingTypeA and |
| μ | dmrs-DownlinkForPDSCH-MappingTypeB |
| 0 | 3 |
| 1 | 4.5 |
| 2 | 9 for frequency range 1 |

TABLE 2-2
PUSCH preparation time for processing capability type 2

| μ | PUSCH preparation time N₂ [symbols] |
|---|---|
| 0 | 5 |
| 1 | 5.5 |
| 2 | 11 for frequency range 1 |

In the above tables, N₁ represents a number of symbols for performing DL transmission on the PDSCH and N₂ represents a number of symbols for preparing UL transmission on the PUSCH; μ represents a subcarrier spacing configuration; MappingTypeA and MappingTypeB represent mapping types A and B on PDSCH in time domain, respectively; and N_{1,0}=14 if PDSCH DM-RS position l₁ for additional DM-RS is l₁=12, or otherwise N_{1,0}=13.

As shown in Tables 1-1 to 2-2, upon obtaining the processing capability information, the network device may determine a corresponding scheduling scheme including certain symbol numbers N₁ and N₂, and configure the terminal device with the scheduling scheme via a higher layer signaling, such as radio resource control (RRC) signaling. However, the service requirements vary from usage scenarios, and particularly, service requirements of a device complexity, a device size, bitrates in uplink (UL) and downlink (DL), the end-to-end latency, the reliability, etc., are relatively high in URLCC and eMBB, but low in LTE-M/NB IoT. Additionally, in some cases, a terminal device with a high requirement of battery life may expect to operate in an operation mode consuming less power, while another terminal device running a time-sensitive application may expect to operate in a more efficient manner and demand higher configuration parameters due to its high requirement of bitrates and latency. Thus, despite of a same processing capability type, it is unreasonable to configure different terminal device instances with a same scheduling scheme.

In order to solve the above technical problem and other potential technical problems in conventional solutions, example embodiments of the present disclosure provide a solution for scaling the time for processing uplink and downlink transmissions. The solution involves a flexible scheduling scheme for the network device to configure different terminal devices with consideration of terminal device features, processing capabilities and service requirements. The flexible scheduling scheme can be determined by scaling the existing scheduling scheme as defined in the above Tables 1-1 to 2-2.

In this way, communications between the terminal device and the network device can benefit from such a flexible and suitable scheduling manner that is designed based on the hardware capabilities and the operation mode of the terminal device or the services provided by the network device, which may in turn reduce the device cost, save the battery life and enhance the productivity and efficiency of either the terminal device or network device.

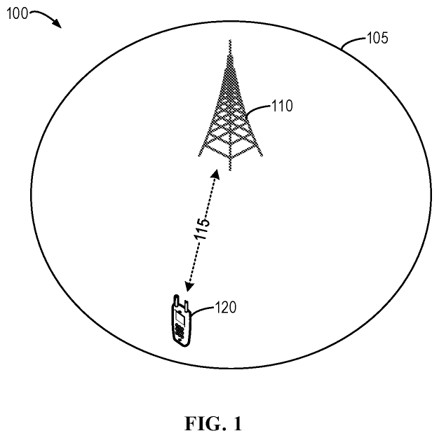

FIG. 1 shows an example environment 100 in which example embodiments of the present disclosure can be implemented. As shown in FIG. 1, the communication environment 100, which may be a part of a communication network, includes a network device 110 hosted a cell 105 and a terminal device 120 located in the coverage of the cell 105. In particular, the terminal device 120 may communicate with the network device 110 via a communication channel 115. For transmissions from the network device 110 to the terminal device 120, the communication channel 115 may be referred to as a DL channel, whereas for transmissions from the terminal device 120 to the network device 110, the communication channel 115 may alternatively be referred to as a UL channel.

In some embodiments, the network device 110 and the terminal device 120 may communicate with each other based on time slots (or slots for short) as defined in the 3GPP specifications. For example, for subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in an increasing order within a frame. There are N_{symb}^{slot} consecutive Orthogonal Frequency Division Multiplexing (OFDM) symbols in a slot where N_{symb}^{slot} depends on the cyclic prefix as given in related 3GPP specifications. The start of slot nₛ^{μ} in a subframe is aligned in time with the start of OFDM symbol nₛ^{μ} N_{symb}^{slot} in the same subframe. Other related definitions and information of slots can be found in existing or future 3GPP specifications.

As described above, the terminal device 120 may report its processing capability in terms of time, for example, by transmitting a capability indicator to the network device 110, or alternatively, the network device 110 may request the terminal device 120 for the capability indicator. The capability indicator indicates the processing capability of the terminal device 120, for example, in terms of time. The processing capability of the terminal device may be associated with a hardware capability of the terminal device, an operation mode of the terminal device, and/or the like.

Upon receipt of the capability indicator, the network device 110 may then determine a target scheduling scheme for the terminal device based on the capability indicator and transmit information associated with the target scheduling scheme to the terminal device 120 via a higher layer signaling, such a RRC signaling. The target scheduling scheme includes a set of configuration and scheduling parameters, which may be used by the network device 110 to configure the terminal device 120, such that scheduling of resources and subsequent communications between the network device 110 and the terminal device 120 are performed according to the target scheduling scheme.

It is to be understood that the number of the terminal devices and the number of the network devices as shown in FIG. 1 are only for the purpose of illustration without suggesting any limitations. The communication environment 100 may include any suitable number of terminal devices, any suitable number of network devices, and any suitable number of other communication devices adapted for implementing embodiments of the present disclosure.

In addition, it would be appreciated that there may be various wireless communications as well as wireline communications (if needed) among all the communication devices. Moreover, it is noted that although the network device 110 is schematically depicted as a base station and the terminal device 120 is schematically depicted as a mobile phone in FIG. 1, it is understood that these depictions are only for example without suggesting any limitation. In other embodiments, the network device 110 may be any other suitable network device, and the terminal device 120 may be any other suitable terminal device.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

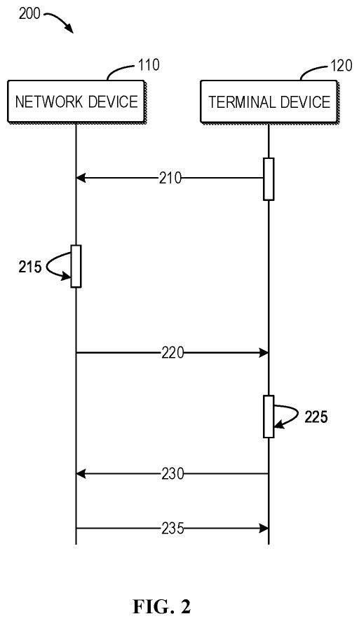

FIG. 2 illustrates an example communication process 200 between the network device 110 and the terminal device 120 in accordance with some embodiments of the present disclosure. For the purpose of discussion, the communication process 200 will be described with reference to FIG. 1. However, it would be appreciated that the communication process 200 may be equally applicable to any other communication scenarios where a network device and a terminal device communicate with each other.

As shown in FIG. 2, the terminal device 120 transmits 210 a capability indicator to the network device 110. Alternatively, the network device 110 may request the terminal device 120 or a core network element for the capability indicator as desired. In some embodiments, the capability indicator may indicate a processing capability of the terminal device 120 in terms of time, and the processing capability of the terminal device 120 is associated with at least one of hardware capability and operation mode of the terminal device 120. For example, the capability indicator may include the processing capability type of the terminal device 120.

Upon obtaining the capability indicator, the network device 110 determines 215 a target scheduling scheme including configuration parameters for the terminal device 120 based on the capability indicator and selectively the service requirements. In some embodiments, the terminal device 120 may select a common scheduling scheme to be the target scheduling scheme, or alternatively derive the target scheduling scheme based on the capability indicator.

In some embodiments, the target scheduling scheme at least includes configuration parameters N₁ and N₂, where N₁ represents a number of symbols for performing DL transmission and N₂ represents a number of symbols for performing UL transmission. For example, in response to the receipt of the capability indicator indicative of the terminal device 120 is of processing capability type 1 and based on the subcarrier spacing configuration μ=0, the network device 110 may determine a target scheduling scheme at least including configuration parameters N₁=8 and N₂=10 as defined in Tables 1 and 2.

The network device 110 then transmits 220 information associated with the target scheduling scheme to the terminal device 120. The information associated with the target scheduling scheme (also referred to information for short) may cause the terminal device 120 to perform uplink and downlink transmissions based on the target scheduling scheme, which will be described in more detail later.

In some embodiments, the information may include an index of the target scheduling scheme, for example, the table index or row index of Tables 1-1 to 2-2. Additionally or alternatively, a new table including different configuration parameters from those of Tables 1-1 to 2-2. The new table can help to facilitate communications between network device and terminal devices with various device features in terms of the device complexity, the processing capability, and the demand for relaxing the processing time on UL and DL.

A new scheduling scheme including different values or ranges of values of configuration parameters from those of Tables 1-1 to 2-2 is proposed and shown in Tables 3-1 and 3-2 below. The scheduling scheme as defined in Tables 3-1 and 3-2 may facilitate, among other things, communications of terminal devices with low device complexity, a limited or reduced processing capability or a demand for relaxing respective processing time on UL and DL.

TABLE 3-1
PDSCH processing time

| | PDSCH decoding time N₁ [symbols] |
|---|---|
| | dmrs-DownlinkForPDSCH-MappingTypeA, |
| μ | dmrs-DownlinkForPDSCH-MappingTypeB |
| 0 | 19-26 |
| 1 | 26-33 |
| 2 | 33-40 |
| 3 | 40-47 |

TABLE 3-2
PUSCH preparation time

| μ | PUSCH preparation time N₂ [symbols] |
|---|---|
| 0 | 26-33 |
| 1 | 33-40 |
| 2 | 40-47 |
| 3 | 47-54 |

In the above tables, N₁ represents a number of symbols for performing DL transmission on the PDSCH and N₂ represents a number of symbols for preparing UL transmission on the PUSCH; μ represents a subcarrier spacing configuration; and

MappingTypeA and MappingTypeB represent mapping types A and B on PDSCH in time domain, respectively.

The new scheduling scheme as shown in above tables 3-1 and 3-2 is designed based on the hybrid automatic repeat request (HARQ) number of 8 and the typical timing advance (TA) of the terminal device as defined in the 3GPP specifications. In this example, the maximum number of symbols for preparing UL transmission should not exceed 8/2*14-2=54, and the threshold value may be set as n/2*14-2, where n is a positive integer.

It is to be understood that the new scheduling scheme as well as the tables 3-1 and 3-2 are applicable to not only the existing processing capability types 1 and 2, but also to the future processing capability types of terminal devices. Additionally, the numbers, values or range of values as shown in tables 3-1 and 3-2 are only for purpose of illustration, without suggesting any limitation. Any suitable numbers, values or range of values may be included in the tables 3-1 and 3-2 to define such a new scheduling scheme that accommodate the processing capability and operation mode of the terminal device 120 while meet requirements of the service provided by the network device 110. The present disclosure is not limited to this aspect.

In some embodiments, the information may include configuration parameters of the target scheduling scheme for the uplink and downlink transmissions, for example, configuration parameters N₁ and N₂ indicative of a respective number of symbols for performing the UL and DL transmissions. In the above example that the network device 110 acknowledges the subcarrier spacing configuration μ=0 and the terminal device 120 being of processing capability type 1 from the capability indicator, and selectively, the network device 110 may further take the requirements of service to be provided into consideration, the network device 110 determines a target scheduling scheme and then transmits the information indicative of N₁=8 and N₂=10 to the terminal device 120.

Additionally or alternatively, the information may indicate the target scheduling scheme in an implicit manner. In some embodiments, the configuration parameters of the target scheduling scheme included in the information may be a scaling factor of a common scheduling scheme preconfigured for both the terminal device 120 and the network device 110. The target scheduling scheme may be derived by scaling the common scheduling scheme with the scaling factor. The scaling factor may be configured by RRC. The scaling factor may include an additive factor or a multiplicative factor for scaling the common scheduling scheme to derive the target scheduling scheme.

For example, the scaling factor may be additive factors d_{1,2} and d_{2,2} for scaling respective PDSCH processing time N₁ and PUSCH preparation time N₂ as defined in the tables 1-1 to 3-2. The scaled PDSCH processing time N_{1′} and the scaled PUSCH preparation time N_{2′} may be calculated as below, for example.

N_{1′}=N₁+d_{1,1}+d_{1,2} (1)

N_{2′}=N₂+d_{2,1}+d_{2,2} (2)

where d_{1,1} is selected based on the number of overlapping symbols of physical downlink control channel (PDCCH) and PDSCH, and d_{2,1}=0 if the first symbol of PUSCH consists of DM-RS only, otherwise d_{2,1}=1, as specified in 3GPP TS 38.133.

In another example, the scaling factor may be multiple factors s₁ and s₂ for scaling respective PDSCH processing time N₁ and PUSCH preparation time N₂ as defined in the tables 1-1 to 3-2. The scaled PDSCH processing time N_{1″} and the scaled PUSCH preparation time N_{2″} may be calculated as below, for example.

N_{1″}=[s₁*N₁]+d_{1,1} or N_{1″}=[s₁*(N₁+d_{1,1})] (3)

N_{2″}=[s₂*N₂]+d_{2,1} or N_{2″}=[s₂*(N₂+d_{2,1})] (4)

where d_{1,1} represents the number of overlapping symbols of PDCCH and PDSCH, and d_{2,1}=0 if the first symbol of PUSCH consists of DM-RS only, otherwise d_{2,1}=1, as specified in 3GPP TS 38.133, and where the operator [ ] denotes the ceiling operation.

With the scaling factor, the target scheduling scheme can be specially designed for a particular type of terminal devices. As such, all kinds of terminal devices with various processing capabilities and hardware structures can be configured with suitable scheduling scheme, regardless of whether the processing capability types of which are the same or not.

It is to be understood that the formulas (1) to (4) are provided only for the purpose of illustration, without suggesting any limitation. Any suitable values and algorithms may be used for scaling configuration parameters, for example, the processing time, as defined in the common scheduling scheme.

In some other embodiments, information may include a threshold of a metric associated with a processing time requirement corresponding to the target scheduling scheme. The threshold of the metric may be determined based on, for example, at least one of a number of multiple input multiple output (MIMO) layers, a modulation and coding scheme (MCS), a transmission block (TB) size, a transmission bandwidth and so on. In this example, the network device 110 may indicate a first common scheduling scheme to be the target scheduling scheme, if a corresponding metric of the terminal device 120 is greater or equal to the threshold of the metric, and a second common scheduling scheme different from the first common scheduling scheme if the corresponding metric of the terminal device 120 is less than the threshold of the metric.

By way of example, given that threshold of the metric is determined based on the number of MIMO layers, the information may include the threshold of the number of MIMO layers, L=2. In a case that the number of MIMO layers supported by the terminal device 120 is greater than or equal to 2, the first common scheduling scheme as defined by tables 1-1 and 2-1 is determined to be the target scheduling scheme. Otherwise, in a case that the number of MIMO layers supported by the terminal device 120 is less than 2, the second common scheduling scheme as defined by tables 1-2 and 2-2 is determined to be the target scheduling scheme.

As another example, given that the threshold of the metric is determined based on the MCS, the information may include the threshold of the index value of MCS, I=20. In a case that the terminal device 120 determines that an index value of the adopted MCS is greater than or equal to 20, for example, any index value within a range of 20 to 31, the first common scheduling scheme as defined by tables 1-1 and 2-1 is determined to be the target scheduling scheme. Otherwise, in a case that the terminal device 120 determines that the index value of the adopted MCS is less than 20, for example, any index value within a range of 0 to 19, the second common scheduling scheme as defined by tables 1-2 and 2-2 is determined to be the target scheduling scheme.

It is to be understood that the numbers, values or range of values are provided only for purpose of illustration, without suggesting any limitation. Any suitable metric, numbers, values or range of values may be selected to define the threshold of the metric associated with a processing time requirement corresponding to the target scheduling scheme. The present disclosure is not limited to this aspect.

Continuing with reference to FIG. 2, after receiving the information from the network device 110, the terminal device 120 determines 225 the target scheduling scheme based on the information. In some embodiments, in a case that the information includes the index of the target scheduling scheme, for example the table indices or row index of tables 1-1 to 3-2, the terminal device 120 may directly determine the target scheduling scheme from at least one common scheduling scheme preconfigured for both the terminal device 120 and network device 110.

In some embodiments, in a case that the information includes configuration parameters of the target scheduling scheme and the configuration parameters indicates respective numbers of symbols for performing the UL and DL transmissions (such as, the numbers of symbols N₁ and N₂), the terminal device 120 may determines the target scheduling scheme by selecting, from the preconfigured scheduling scheme as defined in tables 1-1 to 3-2, a scheduling scheme that includes the respective number of symbols N₁ and N₂, and determine the selected scheduling scheme to be the target scheduling scheme.

As described above, the information may indicate the target scheduling scheme in an implicit manner. In some embodiments, configuration parameters of the target scheduling scheme included in the information may be the scaling factors of a common scheduling scheme, the terminal device 120 may determine the target scheduling scheme by scaling the common scheduling scheme with the scaling factor, for example as defined in the above formulas (1) to (4).

In some embodiments, in a case that the information includes a threshold of a metric associated with a processing time requirement corresponding to the target scheduling scheme, the terminal device 120 may determine the target scheduling scheme based on the threshold of the metric. In the above example, the threshold of the metric is determined based on a number of MIMO layers, L=2, the terminal device 120 may compare the number of MIMO layers supported between the network device 110 and the terminal device 120 with the threshold L=2. In accordance with a determination that the number of MIMO layers supported by the terminal device 120 is greater or equal to the threshold L=2, the terminal device 120 determines the first common scheduling scheme defined by tables 1-1 and 1-2 to be the target scheduling scheme. In accordance with a determination that the number of MIMO layers supported by the terminal device 120 is less than the threshold L=2, the terminal device 120 determines the second common scheduling scheme different from the first common scheduling scheme, for example another scheduling scheme defined by tables 2-1 and 2-2, to be the target scheduling scheme.

Still referring to FIG. 2, the terminal device 120 then performs the uplink transmission and downlink transmission based on the target scheduling scheme. The terminal device 120 may perform UL transmission, for example, by transmitting 230 data to the network device 110. The network device 110 may also perform DL transmission, for example, by transmitting 235 data to the terminal device 120. For example, the terminal device 120 may decode the DL transmission during a period of 8 symbols and prepare data to be transmitted on the PUSCH during a period of 10 symbols. For another example, the terminal device 120 may decode the DL transmission during a period of 24 symbols and prepare data to be transmitted on the PUSCH during a period of 40 symbols by scaling the common scheduling scheme including configurations parameters N₁=8 and N₂=10 with scaling factors s₁=3 and s₂=3. Any other suitable scaled scheduling scheme can be applied to the UL and DL transmissions between the network device 110 and terminal device 120.

By means of information that explicitly or implicitly indicates the target scheduling scheme, the embodiments of the present disclosure can reuse or flexibly adjust the common scheduling schemes and preconfigured tables (e.g., Tables 1-1 to 3-2). Moreover, the solution of the present disclosure can be compatible with the existing hardware structures of terminal devices, and especially, the terminal devices having processing units with low oscillator frequency or the low complexity device with less pipeline units may benefit from such a flexible scheduling and configuration manner.

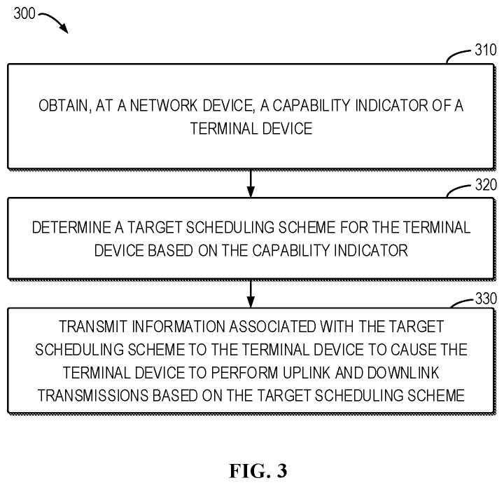

FIG. 3 illustrates a flowchart of an example method 300 in accordance with some embodiments of the present disclosure. In some embodiments, the method 300 can be implemented at a network device, such as the network device 110 as shown in FIG. 1. Additionally or alternatively, the method 300 can also be implemented at other network devices not shown in FIG. 1. For the purpose of discussion, the method 300 will be described with reference to FIG. 1 as performed by the network device 110 without loss of generality.

At block 310, the network device 110 obtains, from the terminal device 120, a capability indicator of the terminal device 120. At block 320, the network device 110 determines a target scheduling scheme for the terminal device 120 based on the capability indicator. At block 330, the network device 110 transmits information associated with the target scheduling scheme to the terminal device 120 to cause the terminal device 120 to perform uplink and downlink transmissions based on the target scheduling scheme.

The terminal device 120 may obtain the capability indicator in a variety of ways. In some embodiments, the terminal device 120 may obtain the capability indicator by receiving the capability indicator from the terminal device 120. In other embodiments, the terminal device 120 may obtain the capability indicator from a core network element. The capability indicator indicates a processing capability of the terminal device 120 in terms of time. The processing capability of the terminal device 120 is associated with at least one of hardware capability and operation mode of the terminal device 120.

In some embodiments, the information associated with the target scheduling scheme may include configuration parameters of the target scheduling scheme for the uplink and downlink transmissions, an index of the target scheduling scheme, a threshold of a metric associated with a processing time requirement corresponding to the target scheduling scheme, and/or the like.

In some embodiments, the configuration parameters may include at least one of: a respective number of symbols for performing the uplink and downlink transmissions, and a scaling factor of a common scheduling scheme preconfigured for both the terminal device 120 and the network device 110.

In some embodiments, the scaling factor may include an additive factor or a multiplicative factor for scaling the common scheduling scheme to derive the target scheduling scheme.

In some embodiments, the threshold of the metric may be determined based on a number of multiple input multiple output (MIMO) layers, a modulation coding scheme (MCS) level, a transmission block (TB) size, a transmission bandwidth, and/or the like.

In some embodiments, the information associated with the target scheduling scheme may be transmitted via a higher layer signaling. The higher layer signaling may include an RRC signaling.

In some embodiments, the target scheduling scheme may indicate at least one of the processing time of a PDSCH, and a preparation time of a PUSCH.

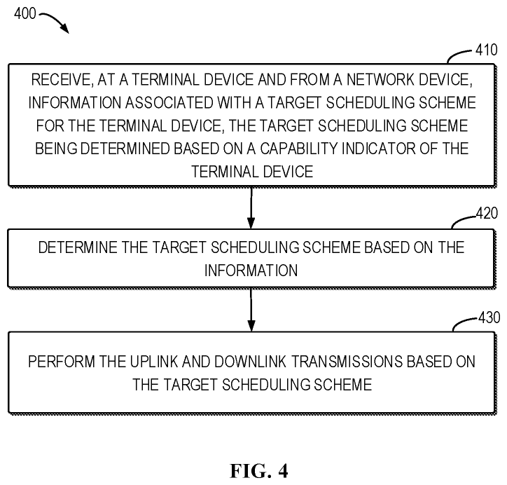

FIG. 4 illustrates a flowchart of another example method 400 in accordance with some embodiments of the present disclosure. In some embodiments, the method 400 can be implemented at a terminal device, such as the terminal device 120 as shown in FIG. 1. Additionally or alternatively, the method 400 can also be implemented at other terminal devices not shown in FIG. 1. For the purpose of discussion, the method 400 will be described with reference to FIG. 1 as performed by the terminal device 120 without loss of generality.

At block 410, the terminal device 120 receives from the network device 110 information associated with a target scheduling scheme for the terminal device 120. The target scheduling scheme is determined based on a capability indicator of the terminal device 120.

At block 420, the terminal device 120 determines the target scheduling scheme based on the information. At block 430, the terminal device 120 performs the uplink and downlink transmissions based on the target scheduling scheme.

In some embodiments, before the receipt of information from the network device 110, the terminal device 120 may transmit the capability indicator to the network device 110. The capability indicator indicates a processing capability of the terminal device 120 in terms of time. The processing capability of the terminal device 120 may be associated with a hardware capability and/or an operation mode of the terminal device 120.

In some embodiments, the information associated with the target scheduling scheme may include configuration parameters of the target scheduling scheme for the uplink and downlink transmissions, an index of the target scheduling scheme, and a threshold of a metric associated with a processing time requirement corresponding to the target scheduling scheme, and/or the like.

In some embodiments, the configuration parameters may include a respective number of symbols for performing the uplink and downlink transmissions. In these embodiments, in the determination of the target scheduling scheme, the terminal device 120 may select at least one common scheduling scheme preconfigured for both the terminal device 120 and the network device 110. The selected common scheduling scheme may be configured with the respective number of symbols for performing the uplink and downlink transmissions. Then, the terminal device 120 may determine the selected common scheduling scheme to be the target scheduling scheme.

In some embodiments, the configuration parameters may include a scaling factor of a common scheduling scheme preconfigured for both the terminal device 120 and the network device 110. In the embodiment, the terminal device 120 may determine the target scheduling scheme by scaling the common scheduling scheme with the scaling factor.

In some embodiments, the scaling factor may include an additive factor or a multiplicative factor for scaling the common scheduling scheme to derive the target scheduling scheme.

In some embodiments, the threshold of the metric is determined based on at least one of a number of multiple input multiple output (MIMO) layers, a modulation coding scheme (MCS) level, a transmission block (TB) size, a transmission bandwidth, and so on.

In some embodiments, the information associated with the target scheduling scheme may include a threshold of a metric associated with a processing time requirement corresponding to the target scheduling scheme. In the embodiment, the terminal device 120 may determine the target scheduling scheme by comparing a metric of the terminal device 120 with the threshold of the metric associated with the processing time requirement. If the metric of the terminal device 120 is greater or equal to the threshold of the metric, the terminal device 120 may determine a first common scheduling scheme predetermined for both the terminal device 120 and the network device 110 to be the target scheduling scheme. If corresponding metric of the terminal device 120 is less than the threshold of the metric, terminal device 120 may determine a second common scheduling scheme different from the first common scheduling scheme to be the target scheduling scheme.

In some embodiments, the terminal device 120 may receive the information associated with the target scheduling scheme via a higher layer signaling. The higher layer signaling may include an RRC signaling.

In some embodiments, the target scheduling scheme indicates at least one of: a processing time of a PDSCH, and a preparation time of a PUSCH.

The present disclosure provides a solution for relaxing the processing time for performing UL and DL transmissions for terminal devices. All kinds of terminal devices varying from device complexities, hardware structures, service requirements, and so on can benefit from such a flexible scheduling and configuration manner. For example, for UE having processing units with low oscillator frequency or a low complexity device with less pipeline units, the processing time can be relaxed as much as possible only to guarantee the processing time under threshold.

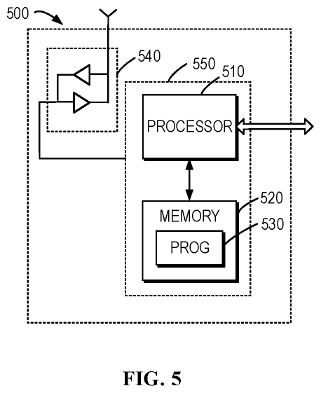

FIG. 5 is a simplified block diagram of a device 500 that is suitable for implementing some embodiments of the present disclosure. The device 500 can be considered as a further example embodiment of the network device 110 and the terminal device 120 as shown in FIG. 1. Accordingly, the device 500 can be implemented at or as at least a part of the network device 110 and the terminal device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 530 is assumed to include program instructions that, when executed by the associated processor 510, enable the device 500 to operate in accordance with the embodiments of the present disclosure, as discussed herein with reference to any of FIGS. 3-4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In some embodiments, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 7-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communications, comprising:
obtaining, at a network device, a capability indicator of a terminal device;
determining a target scheduling scheme for the terminal device based on the capability indicator; and
transmitting information associated with the target scheduling scheme to the terminal device to cause the terminal device to perform uplink and downlink transmissions based on the target scheduling scheme.

2. The method of claim 1, wherein obtaining the capability indicator comprises:
receiving the capability indicator from the terminal device or a core network element, the capability indicator indicating a processing capability of the terminal device in terms of time, the processing capability of the terminal device being associated with at least one of hardware capability and operation mode of the terminal device.

3. The method of claim 1, wherein transmitting the information associated with the target scheduling scheme comprises transmitting at least one of:
configuration parameters of the target scheduling scheme for the uplink and downlink transmissions,
an index of the target scheduling scheme, and
a threshold of a metric associated with a processing time requirement corresponding to the target scheduling scheme.

4. The method of claim 3, wherein the configuration parameters comprise at least one of:
a respective number of symbols for performing the uplink and downlink transmissions, and
a scaling factor of a common scheduling scheme preconfigured for both the terminal device and the network device.

5. The method of claim 4, wherein the scaling factor comprises an additive factor or a multiplicative factor for scaling the common scheduling scheme to derive the target scheduling scheme.

6. The method of claim 3, wherein the threshold of the metric is determined based on at least one of a number of multiple input multiple output (MIMO) layers, a modulation coding scheme (MCS) level, a transmission block (TB) size, and a transmission bandwidth.

7. The method of claim 1, wherein transmitting the information associated with the target scheduling scheme comprises:
transmitting the information associated with the target scheduling scheme via a higher layer signaling.

8. The method of claim 1, wherein the target scheduling scheme indicates at least one of:
a processing time of a physical downlink shared channel (PDSCH), and
a preparation time of a physical uplink shared channel (PUSCH).

9. A method for communications, comprising:
receiving, at a terminal device and from a network device, information associated with a target scheduling scheme for the terminal device, the target scheduling scheme being determined based on a capability indicator of the terminal device;
determining the target scheduling scheme based on the information; and
performing the uplink and downlink transmissions based on the target scheduling scheme.

10. The method of claim 9, further comprising:
transmitting the capability indicator to the network device, the capability indicator indicating a processing capability of the terminal device in terms of time, the processing capability of the terminal device being associated with at least one of hardware capability and operation mode of the terminal device.

11. The method of claim 9, wherein receiving the information associated with the target scheduling scheme comprises receiving at least one of:
configuration parameters of the target scheduling scheme for the uplink and downlink transmissions,
an index of the target scheduling scheme, and
a threshold of a metric associated with a processing time requirement corresponding to the target scheduling scheme.

12. The method of claim 11, wherein the configuration parameters comprise a respective number of symbols for performing the uplink and downlink transmissions, and wherein determining the target scheduling scheme comprises:
selecting at least one common scheduling scheme preconfigured for both the terminal device and the network device, the selected common scheduling scheme being configured with the respective number of symbols for performing the uplink and downlink transmissions; and
determining the selected common scheduling scheme to be the target scheduling scheme.

13. The method of claim 11, wherein the configuration parameters comprise a scaling factor of a common scheduling scheme preconfigured for both the terminal device and the network device, and wherein determining the target scheduling scheme comprises:
determining the target scheduling scheme by scaling the common scheduling scheme with the scaling factor.

14. The method of claim 13, wherein the scaling factor comprises an additive factor or a multiplicative factor for scaling the common scheduling scheme to derive the target scheduling scheme.

15. The method of claim 11, wherein the threshold of the metric is determined based on at least one of a number of multiple input multiple output (MIMO) layers, a modulation coding scheme (MCS) level, a transmission block (TB) size, and a transmission bandwidth.

16. The method of claim 11, wherein the information associated with the target scheduling scheme comprises a threshold of a metric associated with a processing time requirement corresponding to the target scheduling scheme, and wherein determining the target scheduling scheme comprises:
comparing a metric of the terminal device with the threshold of the metric associated with the processing time requirement;
in accordance with a determination that the metric of the terminal device is greater or equal to the threshold of the metric, determining a first common scheduling scheme predetermined for both the terminal device and the network device to be the target scheduling scheme; and
in accordance with a determination that the corresponding metric of the terminal device is less than the threshold of the metric, determining a second common scheduling scheme different from the first common scheduling scheme to be the target scheduling scheme.

17. The method of claim 10, wherein receiving the information associated with the target scheduling scheme comprises:
receiving the information associated with the target scheduling scheme via a higher layer signaling.

18. The method of claim 9, wherein the target scheduling scheme indicates at least one of:
a processing time of a physical downlink shared channel (PDSCH), and
a preparation time of a physical uplink shared channel (PUSCH).

19. A device for communications, comprising:
a processor;
configured to cause the device to perform the method of claim 1.

20.-22. (canceled)
